(19) United States
(12) Patent Application Publication
(10) Pub. No.: US 2015/0206429 A1
(43) Pub. Date: Jul. 23, 2015

(54) METHODS AND APPARATUS TO ACTIVATE TRAFFIC SIGNALS

(71) Applicant: Bytemind, LLC, Hawthorn Woods, IL (US)

(72) Inventors: Paul Bishop, Hawthorn Woods, IL (US); Lane D. Hudson, Des Plaines, IL (US)

(21) Appl. No.: 14/598,944

(22) Filed: Jan. 16, 2015

Related U.S. Application Data
(60) Provisional application No. 61/928,683, filed on Jan. 17, 2014.

(51) Int. Cl. G08G 1/07; G08G 1/042

(52) U.S. Cl. CPC G08G 1/07; G08G 1/042

(57) ABSTRACT

Methods and apparatus are disclosed to activate a traffic control system by enhancing a presence of a vehicle. An example traffic control activator includes a housing formed from an electrically insulating material. An example traffic control activator also includes an annular sensor interface formed from an electrically conducting material disposed within a cavity formed within the housing, the annular sensor interface to produce a first electromagnetic field when exposed to a second electromagnetic field of an inductive traffic sensor.

### RELATED APPLICATIONS

This patent claims the benefit of U.S. Provisional Patent Application Ser. No. 61/928,683, filed Jan. 17, 2014, which is herein incorporated by reference in its entirety.

### FIELD OF THE DISCLOSURE

This disclosure relates generally to the field of traffic signal activation, and, more particularly, to activating traffic control systems by enhancing a presence of a vehicle.

### BACKGROUND

A large number of traffic control systems use wire coils embedded in roadways to control traffic signals that manage left-turn lanes, through lanes, and side streets. These traffic control systems detect vehicles above the wire loop. The sensitivity of the traffic control system is set so that larger vehicles, such as a car (e.g., a sedan, a minivan, a sport utility vehicle (SUV), etc.), will trigger the traffic control system. However, as a result, some smaller vehicles (e.g., small cars, motorcycles, bicycles, mopeds, motorized scooters, etc.) do not trigger these traffic control systems. Recognizing this problem, many states legally allow trapped drivers to ignore red lights after a certain period of non-detection and dangerously drive through the intersection. Safety is compromised in situations where drivers must disobey traffic signals to proceed through the intersection.

### BRIEF DESCRIPTION OF THE DRAWINGS

FIG. 1 illustrates an example intersection with an example traffic control system and an example traffic signal activator mounted to an example vehicle.

FIG. 2 illustrates an example primary alternating magnetic field radiating from an example inductive loop of the example traffic control system.

FIG. 3 illustrates an example traffic signal activator mounted to an example vehicle.

FIG. 4 illustrates a secondary alternating magnetic field radiating from an annular sensor interface of the traffic signal activator mutually coupled with the primary alternating magnetic field radiating from the inductive loop of the traffic control system.

FIG. 5 illustrates an example oscillating signal driving the inductive loop of the traffic control system before and after the inductive loop is damped.

FIG. 6 illustrates the example traffic signal activator mounted to an underside portion of the example vehicle.

FIG. 7 illustrates the example traffic signal activator mounted to an example fork of the example vehicle.

FIGS. 8A and 8B illustrate an example of the example traffic signal activator being deployably mounted to the example vehicle.

FIG. 9 illustrates an example of the example traffic signal activator mounted on a frame of the example vehicle.

FIG. 10 illustrates an example hand deployable example traffic signal activator.

FIG. 11 is a flow diagram that illustrates an example interaction between an example traffic control system and an example traffic signal activator.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part indicates that there is no intermediate part between the two parts. Additionally, times indicated on the figures are not to scale. Instead, to clarify interactions, times between events may be increased or decreased.

### DETAILED DESCRIPTION

Examples disclosed herein may be used to activate traffic control systems by passively simulating the presence of a larger vehicle. For example, traffic control systems may incorporate inductive loops embedded beneath a lane (e.g. a turn-dedicated lane, a straight through lane, etc.) in a roadway. The traffic control system controls traffic signals at an intersection. For example, during off-hours (e.g., night times, early morning, etc.), full time, and/or during rush hour, infrequently used roads (e.g., rural roads, left-turn lanes, etc.) and/or side-streets that intersect major roads may be controlled so that the cross-traffic is not stopped except when a vehicle is present in or near the inductive loop.

To detect vehicles, the example traffic control system drives an oscillating signal onto the inductive loop to produce an alternating magnetic field. The traffic control system detects metallic objects with a sufficient conductance profile (e.g., large vehicles, etc.) that come within or near the inductive loop. The traffic control system detects changes in the oscillating signal. Upon detecting a vehicle, the traffic control system triggers a traffic signal that, in turn, signals (e.g. activates a green light while activating a red light for cross-traffic, etc.) the vehicle to proceed through the intersection. Some vehicles, however, fail to trigger traffic control systems with inductive loops. For example, smaller vehicles (e.g., mopeds, motorcycles, bicycles, small cars, motorized scooters, etc.) may not have a sufficient conductance profile to trigger the traffic control system. Additionally, vehicles that have composite bodies and/or vehicles with frames far above the roadway may also not trigger the traffic control system.

In the examples disclosed and described herein, a traffic signal activator is mounted and/or deployed near the surface of the roadway within the inductive loop of the traffic control system. The alternating magnetic field of the inductive loop of traffic control system may induce eddy currents in an annular sensor interface of the traffic signal activator. As the eddy currents are induced, the traffic signal activator produces a magnetic field with an opposite polarity to the magnetic field of the inductive loop. The alternating magnetic field of the traffic signal activator may induce eddy currents into the inductive loop and may damp the alternating magnetic field of the inductive loop. The induced eddy currents in the inductive loop may reduce the inductance of the inductive loop, which may reduce the impedance of the inductive loop. As a result, the oscillating signal may change. The traffic control system may detect the change in the oscillating signal and may trigger the traffic signal.

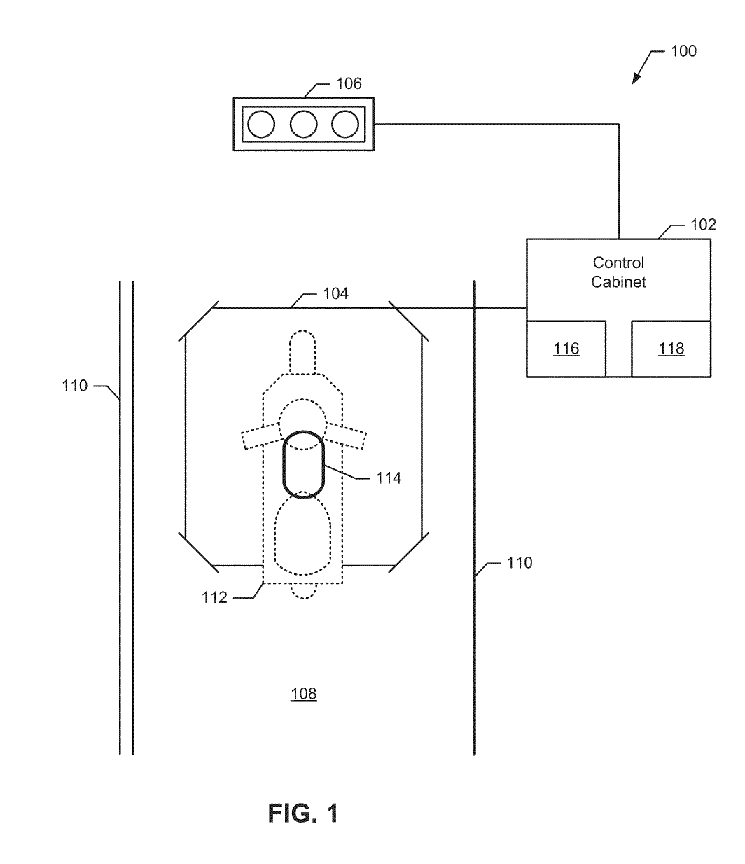

FIG. 1 illustrates an example traffic signal control system 100 with an example control cabinet 102 connected to an example inductive loop 104. In the illustrated example, control cabinet 102 is connected to a traffic signal 106. In some examples, the control cabinet 102 is connected to multiple traffic signals 106 (e.g., opposing traffic signals, cross-traffic traffic signals, etc.) and/or multiple inductive loops 104. In the illustrated example, the inductive loop 104 is embedded below a road surface 108 between lane boundaries 110 (e.g. lane dividing lines, curbs, traffic barriers, etc.). In some examples, the inductive loop 104 is embedded one to two inches below the road surface 108 and/or is made of multiple windings of conductive wire.

The example traffic control system 100 detects when an example vehicle 112 (e.g., a moped, a motorcycle, a bicycle, a truck, a motorized scooter, etc.) equipped with an example traffic signal activator 114 is located within the inductive loop 104. In some examples, upon detecting the example vehicle 112, the example traffic control system 100 controls the traffic signals 106 to signal the vehicle 112 to turn and/or cross an intersection. In some examples, when the example vehicle 112 is detected, the example traffic control system starts a countdown timer and causes the traffic signal 106 to signal the example vehicle 112 to turn and/or cross the intersection (e.g. provide a turn signal, a green light, etc.) when the countdown timer reaches zero.

In the illustrated example, the example inductive loop 104 has an inductance value and an impedance value. The inductance value of the inductive loop 104 is related to the impedance value of the example inductive loop 104. Raising and lowering the inductance value raises and lowers the impedance value of the inductive loop 104. However, the relationship between the inductance value and the impedance value may not be linear.

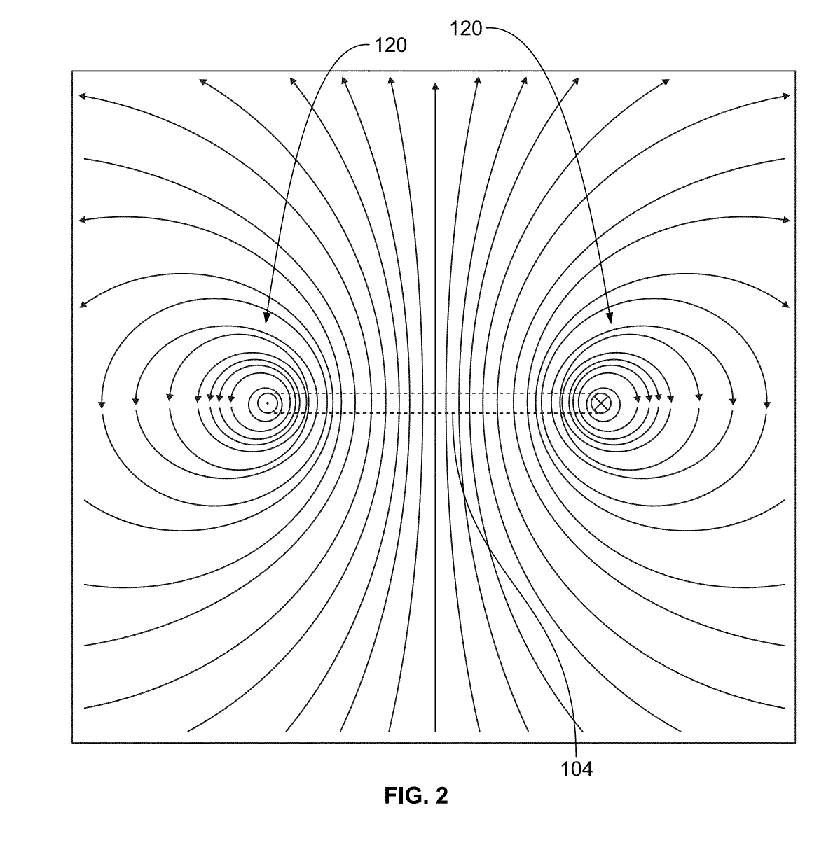

In the illustrated example of FIG. 1, the example control cabinet 102 has an example driving system 116 and an example detecting system 118. The example driving system 116 has an oscillator (e.g., a Colpitts-type oscillator) that drives an oscillating signal into the inductive loop 104 at a frequency. In some examples, the frequency of the oscillating signal is between 20 kHz to 200 kHz. The frequency of the oscillating signal is inversely related to the impedance value of the inductive loop 104 (e.g., the higher the impedance value, the lower the frequency). As FIG. 2 illustratively shows, in some examples, the oscillating signal causes a primary alternating magnetic field 120 to radiate from the inductive loop 104. While the example primary alternating magnetic field 120 illustrated in FIG. 2 shows the magnetic field in one direction, the primary alternating magnetic field 120 alternated directions at the frequency of the oscillating signal.

The example detecting system 118 of FIG. 1 measures the frequency of the oscillating signal. In the illustrated example, the example detecting system 118 measures the frequency of the oscillating signal when a vehicle (e.g., vehicle 112) is not within the inductive loop 104 to establish a baseline frequency measurement. In some examples, the example detecting system 118, from time to time, measures the frequency of the oscillating signal when a vehicle (e.g., the vehicle 112 of FIG. 1) is not within the inductive loop 104 to update the baseline frequency measurement to compensate for changes in environmental factors, such as, a change temperature, rain, snow, etc. In the illustrated example, the detecting system 118 detects a vehicle (e.g., the vehicle 112 of FIG. 1) when the frequency of the oscillating signal deviates beyond a tolerance from the baseline frequency measurement.

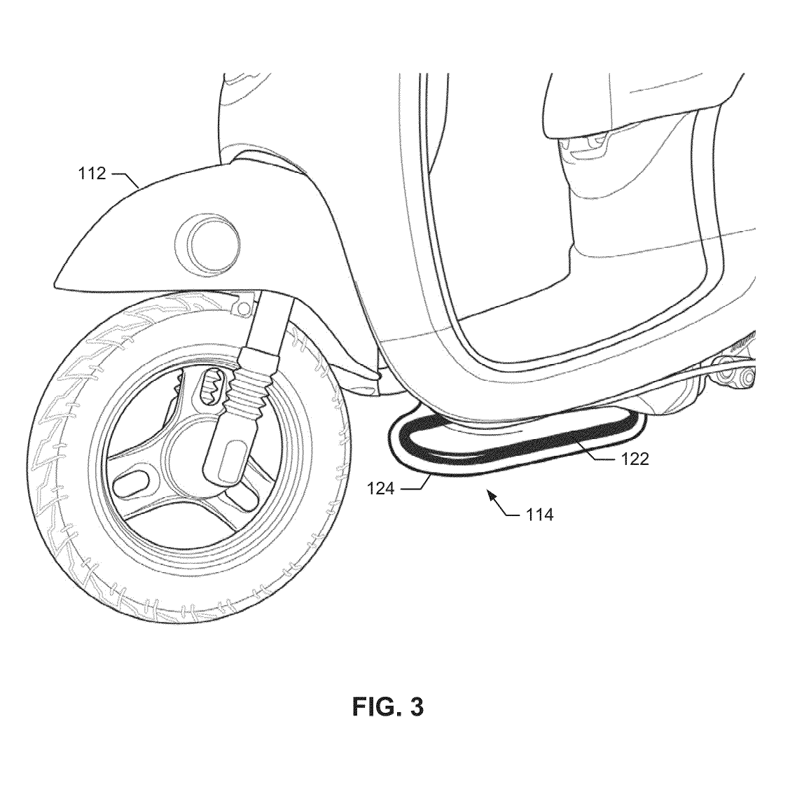

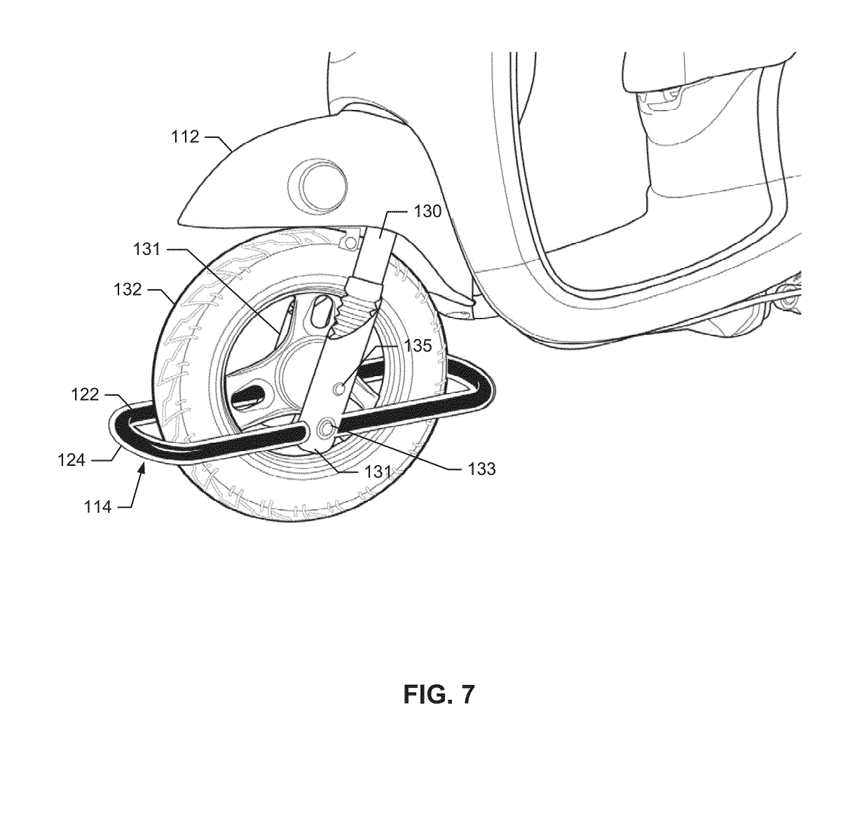

FIG. 3 illustrates the example traffic signal activator 114 of FIG. 1. In the illustrated example, the example traffic signal activator 114 has an example annular sensor interface 122 and an example housing 124. In the illustrated example, the annular sensor interface 122 is elliptical. However, the annular sensor interface 122 may be any shape. In some examples, the annular sensor interface 122 is a convex shape (e.g., circular, rectangular, hexagonal, etc.). In the illustrated example, the annular sensor interface 122 has a length and a width proportioned to allow the annular sensor interface 122 to be mounted on a vehicle (e.g., the example vehicle 112 of FIG. 1) and/or to maximize the size of the annular sensor interface 122. As disclosed in more detail below in connection with FIG. 7, in some examples, the annular sensor interface 122 is sized to fit around a wheel of the vehicle 112. In some examples, the annular sensor interface 122 is 16 inches by 10 inches. The annular sensor interface 122 of the illustrated example is be made of an electrically conductive material (e.g., silver, copper, aluminum, zinc, nickel, iron, carbon (graphene)). In some examples, the electrically conductive material of the example annular sensor interface 122 is at least partially a diamagnetic material (e.g., copper, silver, gold, etc.).

In some examples, at least a portion of the housing 124 is made of an electrically insulating martial (e.g., rubber, Teflon, plastic (e.g., polyethylene), ceramic, etc.) to electrically isolate the annular sensor interface 122 from any electrically conductive portion of the vehicle 112. In the illustrated example, the housing 124 also protects the annular sensor interface 122 from external conditions, such as rain, rocks, snow, etc. In some examples, the annular sensor interface 122 is encased in the housing 124. In other examples, the annular sensor interface 122 is attached to the housing 124 via non-conductive fasteners (e.g., screws, bolts, etc.).

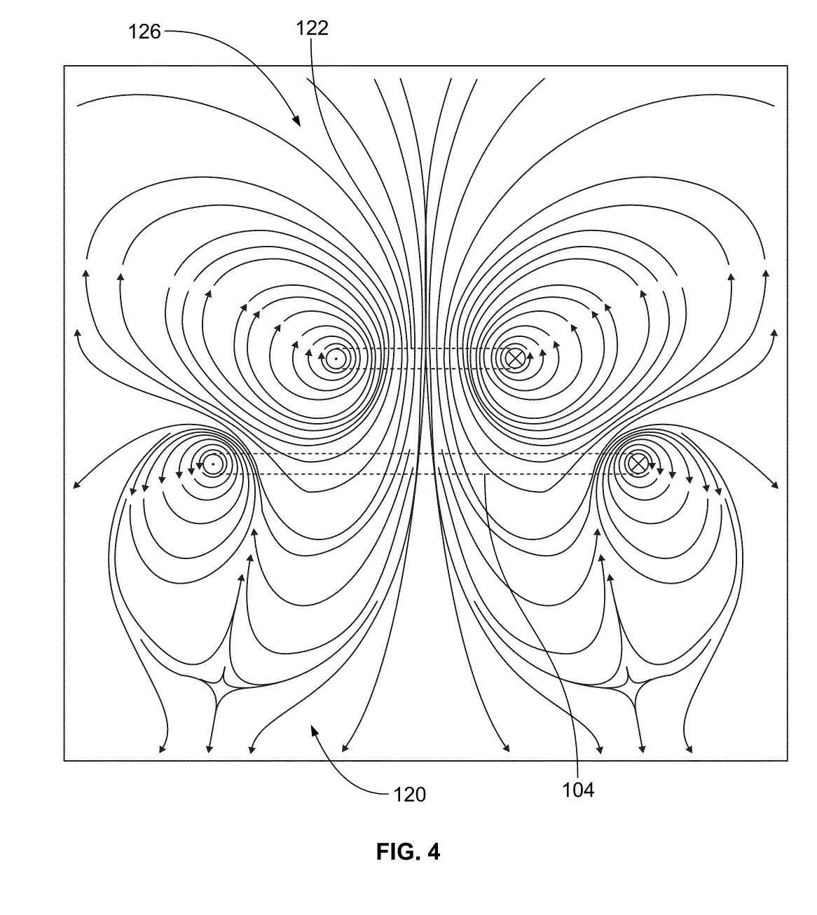

In the illustrated example of FIG. 4, when the example traffic signal activator 114 (FIG. 1) enters the inductive loop 104 (FIG. 1) of the traffic signal control system 100 of FIG. 1, the primary alternating magnetic field 120 induces eddy currents in the annular sensor interface 122. The eddy currents in the annular sensor interface 122 produce an opposing secondary alternating magnetic field 126 with a polarity opposite the primary alternating magnetic field 120. In the illustrated example, the secondary alternating magnetic field 126 suppresses the primary alternating magnetic field 120 emanating from the inductive loop 104 through mutual inductance. The mutual inductance between the inductive loop 104 and the annular sensor interface 122 is given by Equation 1 below.

$$M = \frac{Φ}{I} , . \qquad ( Equation 1 )$$

In Equation 1 above, M is the mutual inductance between the inductive loop 104 and the annular sensor interface 122, Φ is a magnetic flux of the annular sensor interface 122, and I is a current flowing through the inductive loop 104 from the oscillating signal. The higher the mutual inductance, the greater effect the traffic signal activator 114 has on the frequency of the oscillating signal.

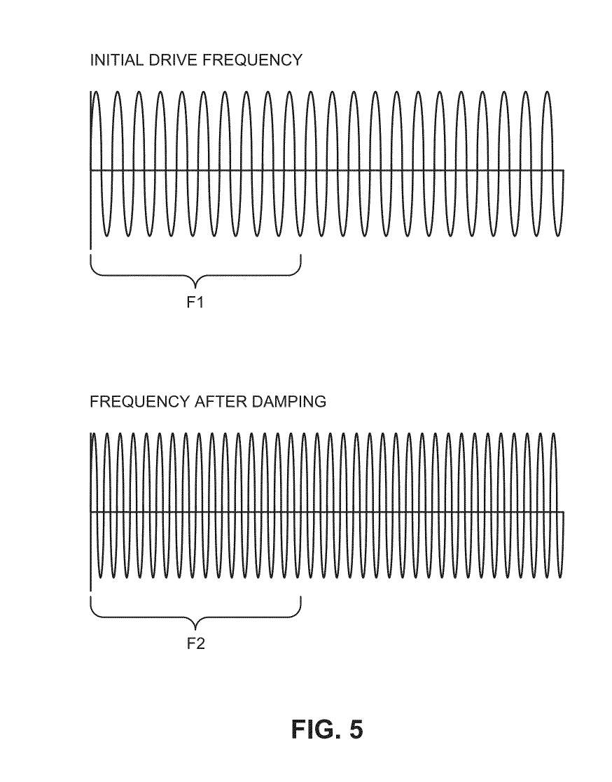

In the illustrated example, the eddy current induced in the inductive loop 104 by the secondary alternating magnetic field 126 reduces the inductance value of the inductive loop 104 and, as a result, reduces the impedance value of the inductive loop 104. Reducing the impedance of the example inductive loop 104 increases the frequency of the example oscillating signal produced by the example oscillator of the driving system 116. In the illustrated example of FIG. 5, the example oscillator of the example driving system 116 of FIG. 1 initially drives the oscillating signal at a frequency F1. When the impedance value of the inductive loops 104 is reduced, the example oscillator drives the oscillating signal at a frequency F2. In the illustrated example, the frequency F2 is greater than the frequency F1. The example detecting system 118 of FIG. 1 detects the change in frequency from frequency F1 to frequency F2. When the oscillating signal frequency crosses a detection threshold frequency, the example detecting system 118 detects the change in the frequency, and the example traffic control system 100 of FIG. 1 changes the example traffic signal 106 (FIG. 1) to indicate that a vehicle (e.g., the vehicle 112 of FIG. 1) may turn/proceed through the intersection.

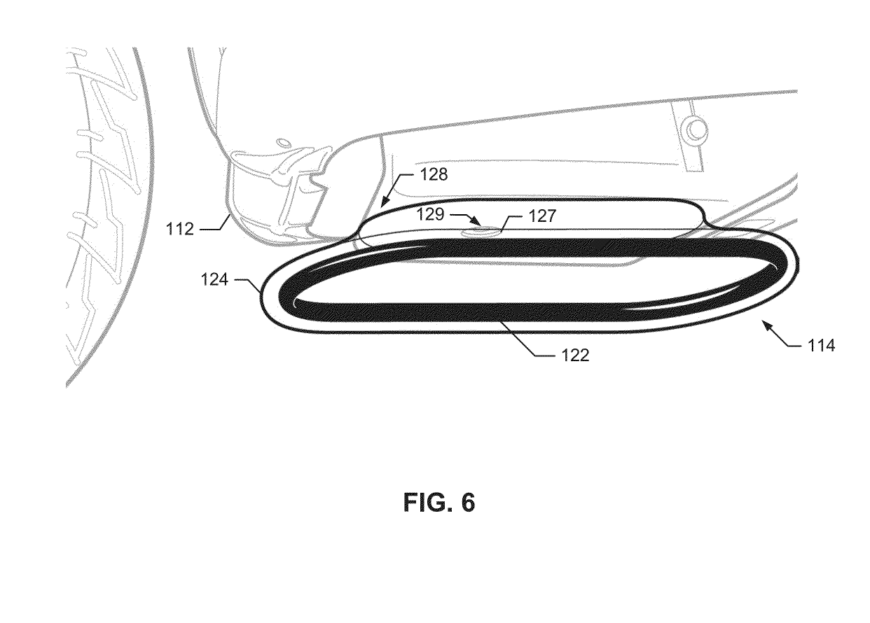

In the examples illustrated in FIGS. 6-8, the traffic signal activator 114 is mounted to the vehicle 112. In the illustrated examples, the traffic signal activator 114 is suspended (e.g., by the housing 124) a distance above the roadway surface 108 (FIG. 1). In some examples, the distance is between six inches and ten inches. The example traffic signal activator 114 is electrically isolated from the vehicle 112.

In the illustrated example of FIG. 6, the example traffic signal activator 114 is mounted to an underside portion 128 of the vehicle 112. In some examples, the traffic signal activator 114 is mounted to the vehicle 112 via an aperture 127 defined by the housing 124 and a fastener (e.g., a screw, a bolt, etc.). In some such examples, the underside portion 128 of the vehicle 112 has a threaded opening 129 to accept the fastener. In the illustrated example, the housing 124 of the traffic signal activator 114 is mounted so that the annular sensor interface 122 is parallel to the road surface 108 (e.g., the annular sensor interface 122 is normal to the primary alternating magnetic field of FIGS. 2 and 4 when the traffic control system 122 is within the inductive loop 104). In some examples, the example annular sensor interface 122 deviates from being parallel with the road surface 108. In the illustrated example, the annular sensor interface 122 is disposed within a cavity formed by the housing 124. In some such examples, the annular sensor interface 122 is between an interior portion of the housing 124 defining the cavity and the exterior portion of the housing 124. Additionally, in the illustrated example, the example housing 124 electrically isolates the example annular sensor interface 122 from the underside portion 128 of the example vehicle 112.

In the illustrated example of FIG. 7, the example traffic signal activator 114 is coupled to a fork 130 of the vehicle 112 via a fork cap 131. The traffic signal activator 114 of the illustrated example extends around an example wheel 132 of the example vehicle 112. In the illustrated example of FIG. 7, the traffic signal activator 114 extends around the example wheel 132 that is at the front of the example vehicle 112. In some examples, the example traffic signal activator 114 extends round a back wheel of the example vehicle 112.

The example housing 124 and the fork cap 131 electrically isolate the example annular sensor interface 122 from the example fork 130 of the example vehicle 112. In the illustrated example, the housing 124 substantially conforms to the shape of the annular sensor interface 122. In some examples, the housing 124 and the annular sensor interface 122 pass through apertures defined by the fork cap 131. Fasteners 133 engage the housing 124 and the fork cap 131 to secure the substantially parallel to the road surface 108 (e.g., the annular sensor interface 122 is normal to the primary alternating magnetic field of FIGS. 2 and 4 when the traffic control system 122 is within the inductive loop 104). In some examples, the example annular sensor interface 122 deviates from being parallel with the road surface 108. In some example, the fasteners 133 are non-conductive. In the illustrated example, the fork caps 131 are configured to slide onto the bottom of the fork 130 without interfering with the front shocks of the vehicle 112. The example fork caps 131 are attached to the fork 130 via fasteners 135. In some examples, the fasteners 135 also couple the fork 130 to the wheel hub 137 of the wheels 132 of the vehicle 112.

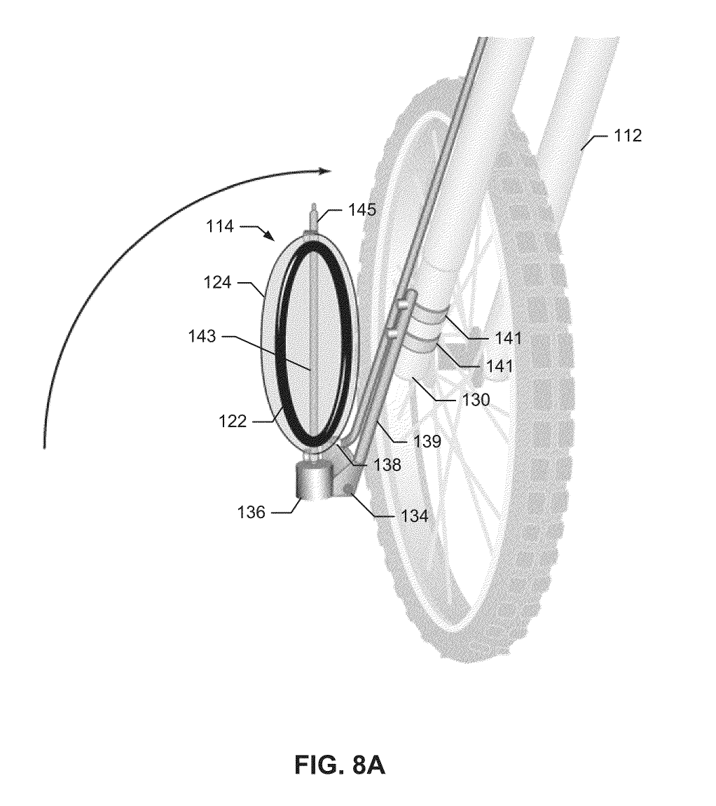

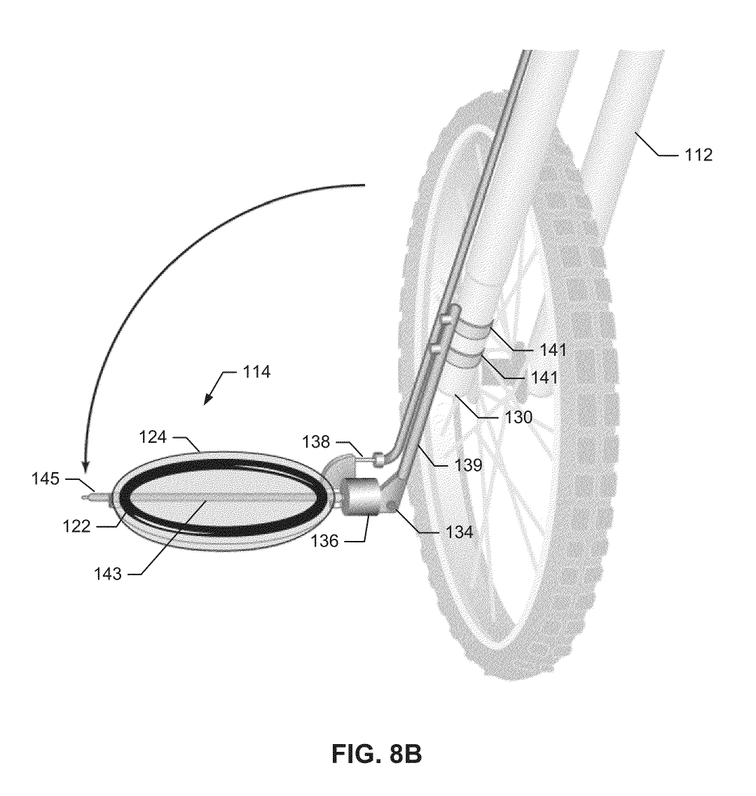

In the illustrated example of FIGS. 8A and 8B, the example traffic signal activator 114 is mounted to the example vehicle 112 via a hinge connection 134. In some examples, the traffic signal activator 114 is fixed to the fork 130 of the vehicle 112 via a mount139 and one or more mounting brackets 141. In the illustrated example of FIG. 8A, the example traffic signal activator 114 is locked into a vertical position substantially perpendicular to the surface of the roadway (e.g., the roadway 108 of FIG. 1) while, for example, the vehicle 112 is being driven by a driver. The driver of the example vehicle 112 deploys the example traffic signal activator 114 from the vertical position illustrated in FIG. 8A to a horizontal position illustrated in FIG. 8B when the example vehicle is within the inductive loop 104 of the traffic signal control system 100. In some examples, the active signal activator 114 is connected to a base 136 via a fastener 143 that engages the housing 124 though a hollow portion of the housing 124. In some examples, a cap 145 fixes the housing 124 relative to the fastener 143 so the housing 124 does not rotate around an axis of the fastener 143. The example based is connected to the mount 139 via the hinge connection 134. In such examples, the position of the base 136is controlled by pedal(s) and/or lever(s) (not shown) through a transfer mechanism 138 (e.g., a Bowden cable, rod(s), hydraulics, etc.). In the illustrated example of FIG. 8B, when the traffic signal activator 114 is in the horizontal position, the annular sensor interface 122 is substantially parallel to the road surface 108 (e.g., the annular sensor interface 122 is normal to the primary alternating magnetic field of FIGS. 2 and 4 when the traffic control system 122 is within the inductive loop 104). In some examples, upon the activation of the traffic control system 100, the traffic signal activator 114 is returned to the vertical position.

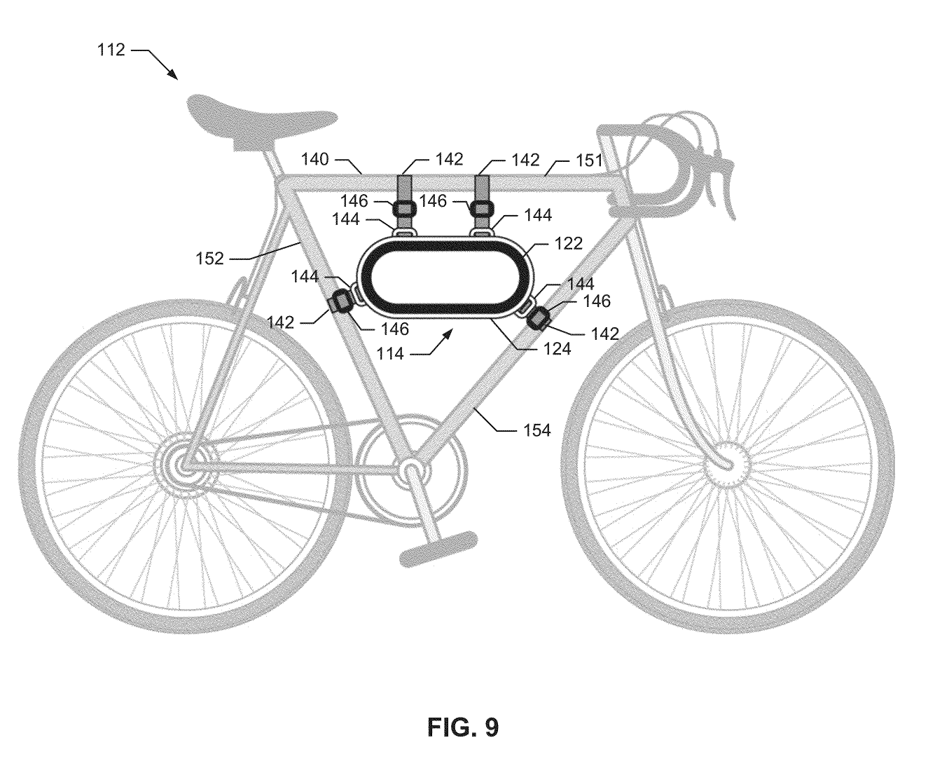

In the illustrated example of FIG. 9, the traffic signal activator 114 is attached to a frame 140 of the vehicle 112 (e.g., a bicycle, etc.) via one or more straps 142. In the illustrated example, the straps 142 wrap around the frame 140 and one or more loops 144 protruding from the housing 124 of the active signal activator 114. In some examples, the straps 142 may be fastened with a fastening device 146 (e.g., a slide release buckle, a ladder lock buckle, Velcro™, etc.). In the illustrated example, when the straps 142 are engaged with the housing 124 and the body of the vehicle 112, the housing is situated in a plane formed by a top tube 151, a seat tube 152, and a down tube 154 of the vehicle 112. In the illustrate example, the driver of the vehicle 112 deploys the traffic signal activator 114 by pivoting the vehicle 112 so that the traffic signal activator 114 is substantially parallel (e.g., the annular sensor interface 122 is normal to the primary alternating magnetic field of FIGS. 2 and 4) with the road surface 108 (FIG. 1) within the inductive loop 104 (FIG. 1) of the traffic control system 110 (FIG. 1)

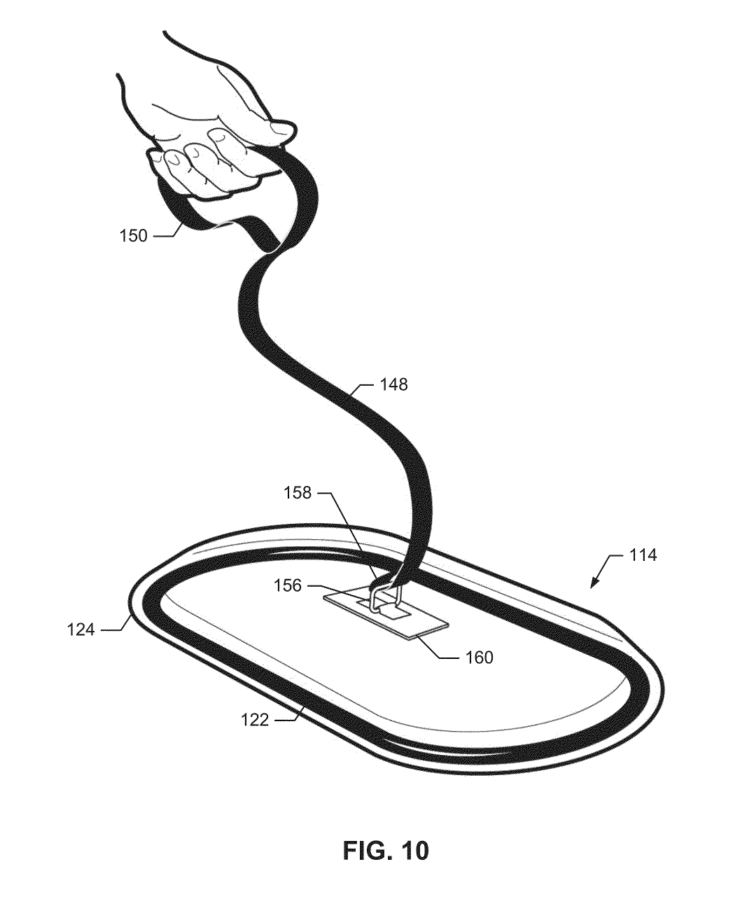

In the illustrated example of FIG. 10, the traffic signal activator 112 is attached to a tether 148. The tether 148 of the illustrated example has a hand loop 150. The example tether 148 engages a ring 156 (e.g., a D-ring, etc.) via a ring loop 158 formed by the tether 148. In some examples, the ring 158 is coupled to the housing 124 via a plate 160 fixed to the housing 124. In some examples, the driver of the vehicle 112 deploys the example traffic signal activator 114 by placing the example traffic signal activator 114 of FIG. 9 on the road surface 118 when within the inductive loop 104 of the traffic signal control system 100. Upon the activation of the example traffic control system 100, the driver uses the example tether 148 to retrieve the example traffic signal activator 114.

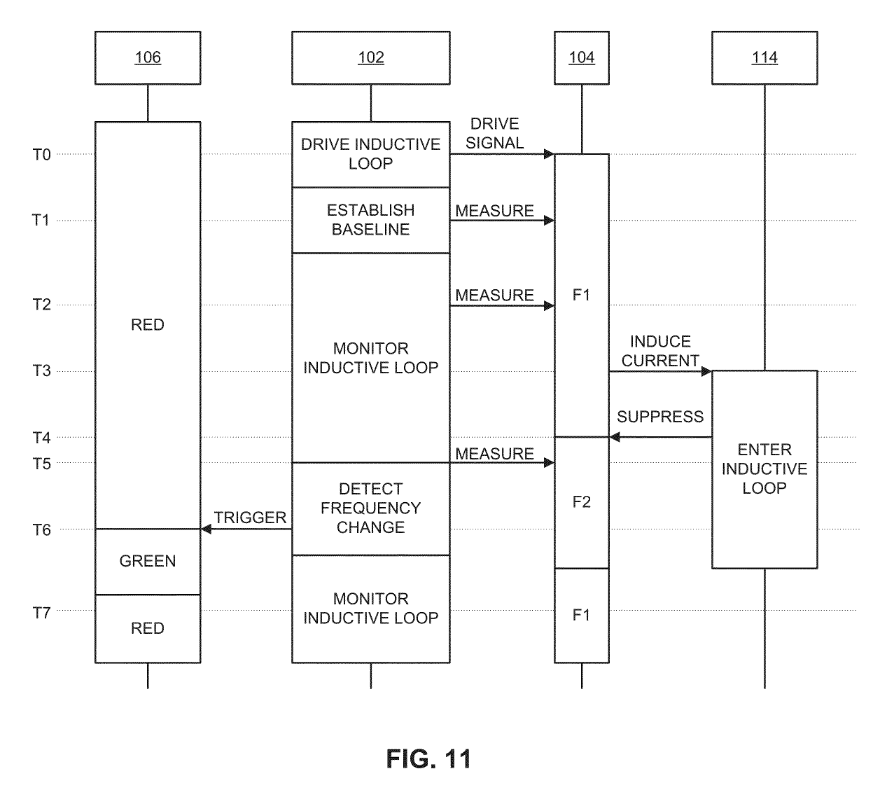

FIG. 11 depicts a flow datagram illustrating an example interaction between the example traffic control system 100 of FIG. 1 and the example traffic signal activator 114 of FIGS. 1 and 3. Initially, at time T0, the driving system 116 (FIG. 1) of the control cabinet 102 (FIG. 1) drives an oscillating signal onto the induction loop 104 at a frequency F1. At a time T1, the detection system 118 (FIG. 1) of the example control cabinet 102 measures the frequency of the oscillating signal to establish a baseline frequency. As shown at an example time T2, from time to time, the detection system 118 measures the frequency of the oscillating signal. In the illustrated example, at T2, the frequency of the oscillating signal is frequency F1. At a time T3, the example traffic signal activator 114 enters the example inductive loop 104 (FIG. 1). The example primary alternating magnetic field 120 (FIG. 2) induces eddy currents in the example annular sensor interface 122 (FIG. 3) of the example traffic signal activator 114. At a time T4, the example secondary alternating magnetic field 126 (FIG. 4) suppresses the primary alternating magnetic field 120. As a result, the oscillating signal begins to oscillate at a frequency F2. At a time T5, the detection system 118 measures the frequency of the oscillating signal and detects that the frequency has changed. At a time T6, the control cabinet 102 changes the traffic signal 106 to indicate that a vehicle (e.g., the vehicle 112 of FIG. 1) may turn/proceed through the intersection. Finally, at a time T7, after the traffic signal activator 114 leaves the inductive loop 104, the frequency of the oscillating signal is the frequency F1 and the detection system 118 monitors oscillating signal to detect another vehicle.

For example, when a motorcycle (e.g., a vehicle 112) equipped with a traffic signal activator 114 enters perimeter of the inductive loop 104 at a traffic signal 106 that is red, the primary alternating magnetic field 120 of the inductive loop 104 induces a current in the annular sensor interface 122 of the traffic signal activator 114. As a result, an opposing secondary alternating magnetic field 126 is generated by the annular sensor interface 114, which suppresses the primary alternating magnetic field 120. The suppression of the primary alternating magnetic field 120 increases the frequency of the oscillating signal of the inductive loop 104. When the detection system 118 detects the change in frequency of the oscillating signal, the control cabinet 102 signals for the traffic control signal 106 to change to green. In such an example, the motorcycle may proceed through the intersection causing the traffic signal activator 114 to exit the inductive loop 104. The frequency of the oscillating signal of the inductive loop 104 returns to its baseline frequency.

From the foregoing, it will be appreciated that the above disclosed methods and apparatus do not require extra electronics to be installed on a vehicle. Additionally, the above disclosed methods and apparatus provide for multiple configurations to be mounted on the vehicle.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A traffic control activator comprising:
a housing formed from an electrically insulating material; and
an annular sensor interface formed from an electrically conducting material disposed within a cavity formed within the housing, the annular sensor interface to produce a first electromagnetic field when exposed to a second electromagnetic field of an inductive traffic sensor.

2. A traffic control activator as defined in claim 1, further comprising a fastener, the fastener to interface with an aperture defined by the housing and a threaded opening defined by a surface on an underside of a vehicle.

3. A traffic control activator as defined in claim 2, wherein the fastener is made of an electrically insulating material.

4. A traffic control activator as defined in claim 1, wherein the housing is configured to keep the annular sensor interface parallel to a surface of a roadway when the housing is coupled to a vehicle.

5. A traffic control activator as defined in claim 1, wherein the housing is configured to suspend the annular sensor interface six to ten inches above a surface of a roadway when the housing is coupled to a vehicle.

6. A traffic control activator as defined in claim 1, further comprising:
a fastening strap to engage a fastening assembly of the housing;
a fastening device to engage the fastening strap, the fastening device configured to lock the fastener in place when the fastening strap is engaged with the fastening assembly of the housing and wrapped around a portion of a body of a vehicle.

7. A traffic control activator as defined in claim 6, wherein the fastening device is at least one of a slide release buckle or a ladder lock buckle.

8. A traffic control activator as defined in claim 6, wherein the vehicle is a bicycle, and wherein the fastening assembly comprises a plurality of loops protruding from the housing, the plurality of loops positioned around a perimeter of the housing so that when the fastening straps are engaged with the housing assembly and the body of the bicycle, the housing is situated in a plane formed by a top tube, a seat tube, and a down tube of the bicycle.

9. A traffic control activator as defined in claim 1, further comprising:
a mounting bracket coupleable to a fork of a vehicle;
a base coupled to the mounting bracket via a hinge connection; and
the fastener extending from the base to engage the aperture of the housing.

10. A traffic control activator as defined in claim 9, further comprising a cable coupled to the base, when tension is applied to the cable, the housing is in a first position perpendicular to a surface of a roadway, and when tension is not applied to the cable, the housing is in a second position parallel to the surface of the roadway.

11. A traffic control activator as defined in claim 1, wherein the annular sensor interface is elliptical.

12. A traffic control activator comprising:
a housing comprising an electrically insulating material, the housing to defined an opening for a wheel of a vehicle; and
an annular sensor interface comprising an electrically conducting material disposed within a cavity formed within the housing, the annular sensor interface to produce a first electromagnetic field when exposed to a second electromagnetic field of an inductive traffic sensor.

13. A traffic control activator as defined in claim 12, further comprising a fork cap configured to receive a fork of the vehicle within a cavity of the fork cap, the housing and the annular sensor interface to be dispose within an aperture of the fork cap.

14. A traffic control activator as defined in claim 13, further comprising:
a first fastener to engage the housing and the fork cap, and
a second fastener to engage the fork cap and the fork of the vehicle.

15. A traffic control activator as defined in claim 14, wherein the first fastener is made of an electrically insulating material.

16. A traffic control activator as defined in claim 12, wherein the housing substantially conforms to the shape of the annular sensor interface.

17. A traffic control activator comprising:
a housing made of an electrically insulating material;
a ring secured to a top of the housing;
an annular sensor interface made of an electrically conducting material disposed within a cavity formed within the housing, the annular sensor interface to produce a first electromagnetic field when exposed to a second electromagnetic field of an inductive traffic sensor.

18. A traffic control activator as defined in claim 17, further comprising a strap with a distal end and a proximal end, the distal end forming a first loop to engage the ring, and the proximal end forming a loop sized to accommodate a hand.

19. A traffic control activator as defined in claim 17, wherein the ring is secured to the housing by a plate.

20. A traffic control activator as defined in claim 17, wherein the annular sensor interface is elliptical.
